(19) United States
(12) Patent Application Publication
(10) Pub. No.: US 2018/0361657 A1
(43) Pub. Date: Dec. 20, 2018

(54) METHOD OF ADDITIVE MANUFACTURING TO MAKE OBJECTS HAVING IMPROVED AND TAILORED PROPERTIES

(71) Applicant: SABIC GLOBAL TECHNOLOGIES B.V., Bergen op Zoom (NL)

(72) Inventors: Lakshmikant Suryakant POWALE, Delmar, NY (US); Satish Kumar GAGGAR, Hoover, AL (US); Malvika BIHARI, Evansville, IN (US)

(73) Assignee: SABIC Global Technologies B.V., Bergen op Zoom (NL)

(21) Appl. No.: 16/060,542

(22) PCT Filed: Dec. 8, 2016
(86) PCT No.: PCT/US2016/065620

§ 371 Date: Jun. 8, 2018

Related U.S. Application Data
(60) Provisional application No. 62/266,023, filed on Dec. 11, 2015.

(51) Int. Cl. B29C 64/118; B29C 64/336; B29C 64/209

(52) U.S. Cl. CPC B29C 64/118; B33Y 10/00; B29C 64/209; B29C 64/336

(57) ABSTRACT

Disclosed here is a method of making an article, the method including melt extruding a plurality of layers comprising one or more polymers in a preset pattern, wherein the extruded layers comprise one or more first layers comprising a first polymer composition A, and one or more second layers comprising a second polymer composition B different from polymer composition A, and fusing the plurality of layers to provide the article. Further disclosed is an article made by the above process.

### BACKGROUND

Additive manufacturing (also known in the art as “three-dimensional” or “3D” printing) is a process for the manufacture of three-dimensional objects by formation of a plurality of fused layers. The three-dimensional objects are limited in many properties by the choice of polymer used in the additive manufacturing process. It can thus be difficult to produce the objects with properties such as the desired level of flame resistance, flexibility, and aesthetics. Thus, there remains a need in the art for additive manufacturing processes that produce objects with improved properties, tailored to the specific uses desired by the end user.

### SUMMARY

A method of making an article comprises melt extruding a plurality of layers comprising one or more polymers in a preset pattern, wherein the extruded layers comprise one or more first layers comprising a first polymer composition A, and one or more second layers comprising a second polymer composition B different from polymer composition A, and fusing the plurality of layers to provide the article.

Also described herein are the articles produced by the method described above.

An article comprises a plurality of layers, each layer comprising a polymer composition, wherein one or more first layers comprise a first polymer composition A, and one or more second layers comprise a second polymer composition B different from the first polymer composition A.

The above described and other features are exemplified by the following detailed description, examples, and claims.

### DETAILED DESCRIPTION

Disclosed herein are additive manufacturing methods based on melt extrusion of a plurality of layers to form a printed object. At least two of the layers have different polymer compositions. In preferred embodiments, the layers having different polymer compositions are in a repeating sequence that provides the printed object with tailored properties.

The methods can have one or more of the following advantages. The printed object can have properties that are a compromise of the properties of the component polymer compositions. For example, use of a first polymer composition with low flexibility and a second polymer composition with high flexibility can produce an object with intermediate flexibility. The exact property, such as flexibility, can be tunable depending on the ratio of the two polymer compositions in the printed, the sequence of layers used, or both. As another example, use of polymer compositions with different colors or textures can allow provide printed objects with decorative patterns or an otherwise tailored appearance. Use of multiple nozzles during extrusion to extrude different polymer compositions can allow faster production of the printed objects, and increased flexibility in the use of different polymer compositions, different extrusion temperatures, different colors or textures, and the like.

Any property that is influenced, affected, or determined by polymer composition can be tailored by these methods. The properties to be tailored can include coefficient of thermal expansion, density, ductility, elongation, flexural modulus, flexural strength, glass transition temperature, haze, heat capacity, heat deflection temperature, intrinsic viscosity, Izod impact strength, melt viscosity, modulus of elasticity, multiaxial impact, maximum average rate of heat emission at 50 kW, notched Izod impact strength, percent elongation at break, Shore hardness, smoke density, tensile modulus, tensile strength, UL flammability rating, Vicat softening temperature, or yellowness index. Other general properties that can be tailored include antistatic ability, weatherability, chemical resistance, solvent resistance, and scratch and mar resistance. Aesthetic properties such as color, texture, gloss, translucence, transparency, and visual pattern can also be tailored.

In some embodiments, properties can be tailored to provide objects with improved properties such as lighter weight, improved aesthetics, crystallinity, reduced cost (resulting from combining high cost materials with lower cost materials), and improved environmental factors (such as combining recycled materials with virgin materials).

The methods provide options for designing three-dimensional printed objects, particularly because of choice of the combinations of polymer compositions that can be used. In some embodiments, certain polymer compositions are used for certain parts of the object, and other polymer compositions are used for other parts of the object. For example, there are many properties that are primarily important for the exterior part of an object, including aesthetics, chemical resistance, and scratch and mar resistance. Thus it can be beneficial to use a polymer with high chemical resistance for the exterior parts of the object, and use a polymer with lower chemical resistance but higher modulus for the interior parts of the object. As a further example, a shock-absorbing shaft can require high flexibility in its central region, but lower flexibility in its terminal regions for attachment to external objects.

As stated above, multiple layers of different polymer compositions are extruded in a preset sequence. As used herein, “multiple layers” is used in reference to the number of layers in a sequence of polymer compositions, whereas “plurality of layers” is used to refer to the total number of layers used to form the printed object. The number of layers in a sequence of polymer compositions is at least two, and can be up to the total number of layers used to form the article. The number of layers in a sequence depends on the particular sequence of polymer compositions selected, based on the desired properties of the printed object. For example, the number of layers per sequence can be 2 to 200, or 2 to 100, or 2 to 50, or 2 to 20, or 2 to 10. In some embodiments the number of layers per sequence includes 2, 3, 4, 5, or 6 layers.

As used herein, “layer” is a term of convenience that includes any shape, regular or irregular, having at least a predetermined thickness. In some embodiments, the size and configuration two dimensions are predetermined, and on some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments the thickness of each layer as formed is 0.5 millimeters (mm) to 5 mm.

As used herein, “polymer composition” refers to a composition that includes one or more polymers, and can optionally include one or more additives known in the art. A polymer composition can consist of a single polymer and nothing else, for example a polymer composition can be polystyrene. Alternatively, a polymer composition can be a combination of polymers, such as 30% polystyrene and 70% poly(phenylene ether). Alternatively, a polymer composition can be one or more polymers and one or more additives, for example a polymer composition can include 30% polystyrene, 70% poly(phenylene ether), a flame retardant, and an impact modifier.

As used herein, two polymer compositions are “different” if they comprise different polymers, different ratios of the same polymers, different additives, or different levels of the same additives. For example, a polymer composition that is 30% polystyrene, 70% poly(phenylene ether) is different from a polymer composition that is 70% polystyrene, 30% poly(phenylene ether). In some embodiments, where different polymer compositions are identical except for a different amount of a component, the amount of the component can vary by at least +/−5%. For example, a polymer composition having 1.00 weight percent (wt. %) of a flame retardant can differ from the identical composition if it contains 0.95 wt. % or less, or 1.05 wt. % or more of the same flame retardant. In some embodiments, the amount of a component varies by at least +/−10%, or at least +/−20%.

As used herein, two polymers are “different” if they have a different chemical composition, structure, or other property. This can mean, for example, that the polymers comprise different monomers (e.g. polymethyl methacrylate and polyethylene oxide), or the same monomers arranged in a different orientation or linkage, or copolymers with different ratios of constituent monomers, or have different levels of crosslinking. Polymers can also differ if each as a different regiochemistry or configuration, molecular weight, molecular weight distribution, dispersity index, density, hydrophobicity, or other characteristic that affects a polymer property. Where the difference is measured numerically (ratios of copolymers, for example), at least one component can have a level or measurement in one polymer that is at least +/−5% different from the other polymer. In some embodiments, the difference is at least +/−10%, or at least +/−20%.

In some embodiments, the first and second polymer compositions, and optionally additional polymer compositions, are compatible with each other at an interface between them. For the purpose of these embodiments, “compatible with each other at an interface” means that there are sufficiently strong interfacial interactions between the polymer compositions, such as adhesion at the interface, or attractive forces due to physical interactions at the interface. Preferably there is no repulsion and no delamination at the interface. An interface between two polymer compositions preferably has adequate interfacial strength. Interfacial strength (or inter-layer bonding) between adjacent layers of two different polymer compositions can be defined as the force required to peel off or separate the two adjacent layers of two different polymer compositions. Interfacial strength can be measured, for example, by the lap shear test or the peel test. The lap shear test is a qualitative adhesion test method which can be used to predict interlayer adhesion for the printed objects of the disclosure. The polymer composition is molded into flame bars with thickness of 1 mm. Two flame bars of the same or different polymer composition are clamped together and placed in an oven at a temperature 3-5° C. higher than the glass transition temperature of the polymer composition. After cooling the flame bars, the adhesion is characterized as,
i. Weak, for the flame bars which can be pulled apart easily,
ii. Medium, for the flame bars which get welded (due to above-mentioned heat treatment) but still can be pulled apart while the flame bars remaining intact, and
iii. Strong, for the flame bars which get completely welded (due to above-mentioned heat treatment) and cannot be pulled apart without breaking.

In still other embodiments, the different polymers are fully compatible, including blendable or fully miscible, not just at the interface, but also in bulk. For example, poly(phenylene ether) and polystyrene are miscible with each other at all concentrations in bulk. And, such compatible or miscible polymers are always compatible at the interface when printed as alternate layers.

In the method, a first layer comprises polymer composition A; and a second layer is extruded on the first layer wherein the second layer comprises polymer composition B. As used herein “extruded on” and “adjacent” means that the two layers directly contact each other, and no intervening layers are present. The sequence of polymer compositions is selected to provide the desired properties of the article. Where an alternating sequence of a first polymer composition A and a second polymer composition B is used, the sequence of polymer compositions can be expressed as (AB)ₓ, where x is number of times the sequence is repeated and is at least 1. Other polymer composition sequences based on polymer compositions A and B can be used, for example the sequence AABBAABB . . . , which can be expressed as (A₂B₂)ₓ, or AAABB, which can be expressed as (A₃B₂)ₓ, or ABBB, which can be expressed as (AB₃)ₓ. Thus, in an embodiment, the method comprises melt extruding the plurality of layers in a polymer composition sequence (Aₚ,B_{q})ₓ where p is the number of adjacent layers extruded comprising polymer composition A, and q is the number of adjacent layers extruded comprising polymer composition B. The variables p and q can be the same or different. In some embodiments, the variable p and q are each independently 1 to 30, preferably 1 to 20, more preferably 1 to 10 , even more preferably 1 to 5. Further in the foregoing formula, x is at least 1.

All or a portion of the plurality of layers used to form the article can be extruded using a given polymer composition sequence. In some embodiments, all of the plurality of layers of the article are formed using the polymer composition sequence, for example the sequence AB. In other embodiments, a portion of the layers in the article are formed using the polymer composition sequence. The polymer composition sequence can be used to vary the properties of the article in a region of the article, for example provide increased tensile modulus or flexural modulus to the region. The number of layers formed using the polymer composition sequences can be represented by the formula (p+q)*x. In some embodiments, (p+q)*x is at least 1%, at least 10%, at least 25%, at least 50%, at least 80%, or at least 90% of the total number of layers in the article. Alternatively, as described above, (p+q)*x can be the total number of layers in the article.

In still other embodiments, two or more different polymer composition sequences can be used to form an article. For example, a sequence (AB)ₓ₁ can be used to form the layers of one portion of an article, and a sequence (A₂B)ₓ₂ can be used to form the layers of a different portion of the article. The multiple layers formed by each sequence can be adjacent each other, or separated by other layers comprising a single polymer composition, e.g., multiple layers formed comprising polymer composition A or B, or a third, different polymer composition.

In some embodiments, one or more additional layers are extruded on the second layer. For example, the method can further comprise melt extruding 1+n additional layers comprising polymer compositions C(1+n), where n is 0, or 1, or greater than 1, up to 2 less than the total number of layers in the article. When n is zero, one additional layer (a third layer) is extruded onto the second layer comprising polymer composition C(1), which may be referred to herein as “C” for convenience. When n is one, two additional layers (third and fourth layers) are present, where the third layer is extruded on the second layer comprising polymer composition C(1), and the fourth layer is extruded onto the third layer comprising polymer composition C(2). When n is 2, three additional layers (third, fourth and fifth layers) are present, where the third layer is extruded on the second layer comprising polymer composition C(1), the fourth layer is extruded on the third layer comprising polymer composition C(2), and the fifth layer is extruded on the fourth layer comprising polymer composition C(3), and so forth. In some embodiments, n is 0, 1, 2, 3, or 4.

Where three different extrusion polymer compositions are used in a sequence, where A is a first polymer composition, B is a second polymer composition, and C is a third polymer composition, adjacent layers can be extruded comprising polymer compositions in the sequence ABCABC . . . which can be expressed as (ABC)_{y}, or (AₚB_{q}C(1)ᵣ)_{y}, where p is 1, q is 1, and y is the number times the sequence is repeated during formation of the article. Thus, in some embodiments, the method comprises melt extruding the multiple layers in polymer composition sequence (AₚB_{q}C(1)ᵣ . . . C(1+n)_{z})_{y}, where p is the number of adjacent layers extruded comprising polymer composition A, q is the number of adjacent layers extruded comprising polymer composition B, r is the number of adjacent layers extruded comprising polymer composition C(1), and z is the number of layers extruded comprising polymer composition C(1+n). Each of p, q, r, and z can be the same or different. In some embodiments each of p, q, R, and z is independently 1 to 30, preferably 1 to 20, more preferably 1 to 10, even more preferably 1 to 5. The variable y is number of times the sequence is repeated. Preferably, (p+q+r+ . . . +z)*y is at least 1%, at least 10%, at least 25%, at least 50%, at least 80%, or at least 90% of the total number of layers in the article.

In addition to the simple sequences described above, more complex sequences can be used to attain the desired properties.

Some examples of polymer composition sequences that can be used include
([AₚB_{q}]_{g}C(1)ᵣ)_{y} or
(Aₚ[B_{q}C(1)ᵣ]_{g})_{y}
   wherein the variables p, q, r, and y are as defined above, and each g is the same or different and is the number of times the subsequence [AₚB_{q}] or [B_{q}C(1)ᵣ] is repeated, and is at least two, for example 2 to 30, 2 to 20, 2 to 10, or 2 to 5.

Other examples of sequences that can be used include
(AₚB_{q1}C(1)ᵣB_{q2})_{y}
([AₚB_{q1}]_{g}C(1)ᵣB_{q2})_{y}
(Aₚ[B_{q1}C(1)ᵣ]_{g}B_{q2})_{y}
(AₚB_{q1}[C(1)ᵣB_{q2}]_{g})_{y}
([AₚB_{q1}C(1)ᵣ]_{g}B_{q2})_{y}
(Aₚ[B_{q1}C(1)ᵣB_{q2}]_{g})_{y}, or
([AₚB_{q1}]_{g1}[C(1)ᵣB_{q2}]_{g2})_{y},
   wherein the variables p, r, g and y are as defined above, q1 and q2 are the same or different and q1+q1 is the total number of layers comprising polymer composition B; and each g, g1, and g2 is the same or different and is the number of times each subsequence is repeated, and is at least 2, for example 2 to 30, 2 to 20, 2 to 10, or 2 to 5.

Still other examples include
(Aₚ₁B_{q}Aₚ₂C(1)ᵣ)_{y}.
([Aₚ₁B_{q}]_{g}Aₚ₂C(1)ᵣ)_{y}
(Aₚ₁[B_{q}Aₚ₂]_{g}C(1)ᵣ)_{y}
(Aₚ₁B_{q}[Aₚ₂C(1)ᵣ]_{g})_{y}
([Aₚ₁B_{q}Aₚ₂]_{g}C(1)ᵣ)_{y}
(Aₚ₁[B_{q}Aₚ₂C(1)ᵣ]_{g})_{y} or
([Aₚ₁B_{q}]_{g1}[Aₚ₂C(1)ᵣ]_{g2})_{y},
   wherein the variables q, r, g, g1, g2, and y are as defined above, p1 and p2 can be the same or different and p1+p2 is the total number of layers deposited comprising polymer composition A.

Still other examples include
(AₚB_{q}C(1)ᵣ[B_{q}C(2)ₛ]_{g})_{y}, or
(AₚB_{q}C(1)ᵣ[BₛC(2)ₛA_{q}]_{g})_{y}, or
(AₚB_{q}C(1)ᵣ[BₛC(2)ₛB_{q}]_{g})_{y}, or
(AₚB_{q}C(1)ₛ[B_{q}Aₜ]_{g})_{y}, or
(AₚB_{q}C(1)ᵣ[B_{q}AₜB_{q}]_{g})_{y}, or
(AₚB_{q}C(1)ᵣ[B_{q}AₜC(2)ₛ]_{g})_{y},
   wherein the variables p, q, r, s, g, and y are as defined above and u is the number of layers deposited comprising polymer composition C(2).

As stated above, the polymer composition sequence and specific polymer compositions are selected to provide the desired properties of the article. For example, and without being bound by theory, it is believed that polymer layers extruded with layers of low flexibility polymer composition A alternating with layers of high flexibility polymer composition B can produce objects with an intermediate level of flexibility. Thus, a sequence such as (AB)ₓ can optimize a balance between high flexibility and low flexibility; and a sequence such as (AₚB_{q})ₓ where p>q can have flexibility that tends to be more low flexibility. In the foregoing examples, specific sequences that can be used include (A₂B)ₓ, (A₃B_{q})ₓ, (A₄B)ₓ, (A₅B)ₓ, (AB)ₓ, (AB₂)ₓ, (AB₃)ₓ, (A₂B₄)ₓ, and (AB₅)ₓ.

In other embodiments, tailored physical properties can be obtained using a gradient of polymer compositions with different properties. Where the flexibility of polymer compositions A, B, C(1) and C(2) is such that the flexibility of each polymer composition is in the ascending order wherein A<B<C(1)<C(2), sequences of this type include (AₚB_{q1}CᵣB_{q2})_{y} and (AₚB_{q1}C(1)ᵣC(2)ᵤC(1)ᵣB_{q2})_{y}. The polymer compositions with a gradient can even be a set of two or more polymer compositions in different ratios, for example polymer composition A is a low flexibility polymer composition, C(2) is a high flexibility polymer composition, B is a mix of 75% A and 25% C(2), and C(1) is a mix of 25% A and 75% C(2). Again, the number of layers deposited comprising each polymer composition can be adjusted to obtain the desired properties, for example in some embodiments by increasing the fraction of layers comprising ([AₚB_{q1}]_{g}CᵣB_{q2})_{y} r=p=q1=q2. Balanced properties can be obtained in some embodiments by using approximately equal fractions, e.g., (AₚB_{q1}CᵣB_{q2})_{y} where p=q1=r=q2. In the foregoing examples, specific sequences that can be used include (A₃BCB)_{y}, (A₂BCB)_{y}, ([AB]₂CB)_{y}, (A₂B₂CB₂)_{y}, (AB₂CB₂)_{y}, (ABCB)_{y}, (AB₂C₂B₂)_{y}, (ABC₂B)_{y}, (ABC₃B)_{y}, and (A[BC]₂B)_{y}.

Still other specific sequences that can be used wherein a property of the polymer compositions is in the sequence A<B<C(1) include sequences of the formula (Aₚ₁B_{q1}Cᵣ₁B_{q2}Aₚ₂Cᵣ₂)_{y} or (Aₚ₁Cᵣ₁B_{q1}Cᵣ₂B_{q2}Cᵣ₂)_{y} wherein in each formula each p1, q1, r1, p2, q2, and r2 are the same or different, and are 1 to 30, 1 to 20, 1 to 10, or 1 to 4, or 1 to 2. Specific formulas of this type include (AB₂CB₂AC)_{y} and ACBCBC)_{y}.

In some embodiments the layers are extruded at temperatures that differ by at least 5° C. The temperatures can be chosen for each layer to be a suitable extrusion temperature for the polymer composition in the layer.

As stated above, a three dimensional article is manufactured by extruding a plurality of layers in a preset pattern by an additive manufacturing. The material extrusion techniques include techniques such as fused deposition modeling and fused filament fabrication as well as others as described in ASTM F2792-12a. Any additive manufacturing process can be used, provided that the process allows formation of at least two adjacent layers comprising different polymer compositions. In some embodiments, more than two adjacent layers are extruded comprising different polymer compositions The methods herein can be used for fused deposition modelling (FDM), Big Area Additive Manufacturing (BAAM), ARBURG plastic free forming technology, and other additive manufacturing methods.

In some embodiments, large format additive manufacturing systems are employed. These systems utilize pellets of polymeric material in hoppers or bins to form parts. A large extruder converts these pellets to a molten form that are then deposited on a table. Large format additive manufacturing system generally comprise a frame or gantry that may include a print head that is moveable in x, y and/or z direction. Alternately, the print head may be stationary and the part is moveable in x, y and/or z axis. The print head has a supply of feed material in the form of pellets or filament and a deposition nozzle. The polymeric material is stored in a hopper (for pellets) or similar storage vessel near the deposition arm or supplied from a filament spool. The apparatus can include a nozzle for extruding a material. The polymeric material from the barrel is extruded through the nozzle and directly deposited on the build. A heat source may be positioned on or in connection with the nozzle to heat the material to a desired temperature and/or flow rate. The bed may be heated or at room temperature. For some embodiments of large format additive manufacturing systems, the pellets can have a cross-sectional dimension in the range of 0.1 mm to 50 mm, or an aspect ratio of 1 to 10, or combinations thereof. One example of such large format additive manufacturing systems is the Big Area Additive Manufacturing (or BAAM) system developed by Oak Ridge National Laboratory and Cincinnati Manufacturing. BAAM technology is described in US Published Patent Application Nos. 2015/0183159 A1, 2015/0183138 A1, and 2015/0183164 A1 and U.S. Pat. No. 8,951,303 B1, all of which are incorporated herein by reference in their entireties. One embodiment of the extruder for the BAAM system is designed for extruding thermoplastic pellets at 35 lbs/hour through a nozzle and onto a print bed 157×78×34 inches. Estimated throughput of extruder increased to 50-100 lbs/hour with expanded capability. Temperature Max : 500 deg C.; 4 heating zones.

For other embodiments, the polymer compositions are also suitable for use in droplet-based additive manufacturing systems, e.g., the Freeformer™ system by Arburg.

In fused material extrusion techniques, an article can be produced by heating a polymer composition to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted polymer composition fuses to the previously deposited layer, and solidifies upon a drop in temperature. Extrusion of multiple subsequent layers builds the desired shape.

The total number of layers in the article can vary significantly. Generally but not always, at least 20 layers are present. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed. The plurality of layers in the predetermined pattern is fused to provide the article. Any method effective to fuse the plurality of layers during additive manufacturing can be used. In some embodiments, the fusing occurs during formation of each of the layers. In some embodiments the fusing occurs while subsequent layers are formed, or after all layers are formed.

The preset pattern can be determined from a three-dimensional digital representation of the desired article as is known in the art and described in further detail below. In particular, an article can be formed from a three-dimensional digital representation of the article by depositing the flowable material as one or more roads on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build material.”

In some embodiments the layers are extruded from two or more nozzles. In some embodiments the layers are extruded such that all of the layers comprising a given polymer composition are extruded from the same nozzle, and any layers comprising a different polymer composition are extruded from a different nozzle. For example, in a pattern of three compositions A, B, and C, one nozzle extrudes only polymer composition A, one nozzle different from the A nozzle extrudes only polymer composition B, and one nozzle different from the A and B nozzles extrudes only polymer composition C.

In some embodiments, each nozzle extrudes only a given polymer composition (for example, A, B, or C) but there can be multiple nozzles for each composition.

In some embodiments different polymer compositions are extruded from the same nozzle. This can facilitate creation of a variety of layers comprising mixtures of polymers with different ratios. This can particularly facilitate extruding layers in which a sequence of layers form a gradient of mixtures of different polymers.

If multiple nozzles are used, the method can produce the product objects faster than methods that use a single nozzle, and can allow increased facility in terms of using different polymers or blends of polymers, different colors, or textures, and the like.

In some embodiments a support material as is known in the art can optionally be used to form a support structure. In these embodiments, the build material and the support material can be selectively dispensed during manufacture of the article to provide the article and a support structure. The support material can be present in the form of a support structure, for example a scaffolding, that can be mechanically removed or washed away when the layering process is completed to the desired degree. For some embodiments, the build structure and the support structure of the article formed can be extruded using different polymer compositions or different polymer composition sequences. In other embodiments, at least one support structure layer and one adjacent build structure layer are extruded using different polymer compositions or different polymer composition sequences.

Systems for material extrusion are known. An exemplary material extrusion additive manufacturing system includes a build chamber and a supply source for the polymer composition. The build chamber includes a build platform, a gantry, and a dispenser for dispensing the polymer composition, for example an extrusion head. The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other. Alternatively the platform can be configured to move in the horizontal x-y plane and the extrusion head can be configured to move along the z-axis. Other similar arrangements can also be used such that one or both of the platform and extrusion head are moveable relative to each other. The build platform can be isolated or exposed to atmospheric conditions.

In some embodiments, the support structure can be made purposely breakable, to facilitate breakage where desired. For example, the support material can have an inherently lower tensile or impact strength than the build material. In other embodiments, the shape of the support structure can be designed to increase the breakability of the support structure relative to the build structure.

For example, in some embodiments, the build material can be made from a round print nozzle or round extrusion head. A round shape as used herein means any cross-sectional shape that is enclosed by one or more curved lines. A round shape includes circles, ovals, ellipses, and the like, as well as shapes having an irregular cross-sectional shape. Three dimensional articles formed from round shaped layers of build material can possess strong structural strength. In other embodiments, the support material for the articles can made from a non-round print nozzle or non-round extrusion head. A non-round shape means any cross-sectional shape enclosed by at least one straight line, optionally together with one or more curved lines. A non-round shape can include squares, rectangles, ribbons, horseshoes, stars, T head shapes, X shapes, chevrons, and the like. These non-round shapes can render the support material weaker, brittle and with lower strength than round shaped build material.

In some embodiments, the lower density support materials can be made from a non-round print nozzle or round extrusion head. These non-round shaped lower density support materials can be easily removed from build materials, particularly higher density round shaped build materials.

In some embodiments the polymer composition is supplied in a melted form to the dispenser. The dispenser can be configured as an extrusion head. The extrusion head can deposit the thermoplastic composition as an extruded material strand to build the article. Examples of average diameters for the extruded material strands can be from 1.27 millimeters (0.050 inches) to 3.0 millimeters (0.120 inches). Depending on the type of polymer composition, the polymer composition can be extruded at a temperature of 200 to 450° C. In some embodiments the polymer composition can be extruded at a temperature of 300 to 415° C. The layers can be deposited at a build temperature (the temperature of deposition of the thermoplastic extruded material) that is 50 to 200° C. lower than the extrusion temperature. For example, the build temperature can be 15 to 250° C. In some embodiments the polymer composition is extruded at a temperature of 200 to 450° C., or 300 to 415° C., and the build temperature is maintained at ambient temperature.

A wide variety of polymers can be used, provided that they can be melt extruded as described herein. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylene ethers (e.g., polyphenylene ethers), polyarylene sulfides (e.g., polyphenylene sulfides), polyarylenesulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyaryl ether ketones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, polylactic acid, polyglycolic acid, poly-3-hydroxybutyrate, polyhydroxyalkanoate, thermoplastic starch, cellulose ester, silicones, or the like, or a combination comprising at least one of the foregoing polymers. In some embodiments, polyacetals, polyamides (nylons), polycarbonates, polyesters, polyetherimides, polyolefins, and polystyrene copolymers such as acrylonitrile butadiene styrene, are especially useful in a wide variety of articles, have good processability, and are recyclable.

In some embodiments, the polymer is a polystyrene, poly(phenylene ether), poly(methyl methacrylate), styrene-acrylonitrile, poly(ethylene oxide), epichlorohydrin polymer, polycarbonate, acrylonitrile-butadiene-styrene, or a combination comprising at least one of the foregoing polymers.

Exemplary polycarbonates are described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”). In a specific embodiment, the polycarbonate is a homopolymer derived from BPA, for example a linear homopolycarbonate containing BPA carbonate units, such as that available under the trade name LEXAN from the Innovative Plastics division of SABIC. A branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name CFR from the Innovative Plastics division of SABIC can be used.

In other embodiments, the polycarbonate is a copolymer derived from BPA and another bisphenol or dihydroxy aromatic compound such as resorcinol (a “copolycarbonate”). A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade designation XHT from the Innovative Plastics division of SABIC); a copolymer comprising bisphenol A carbonate units and 1,1-bis(4-hydroxy-3-methylphenyl)cyclohexane carbonate units (a BPA-DMBPC copolymer) commercially available under the trade designation DMC from the Innovative Plastics division of SABIC; and a copolymer comprising bisphenol A carbonate units and isophorone bisphenol carbonate units (available, for example, under the trade name APEC from Bayer.

Other polycarbonate copolymers include poly(siloxane-carbonate)s, poly(ester-carbonate)s, poly(carbonate-ester-siloxane)s, and poly(aliphatic ester-carbonate)s. Specific poly(carbonate-siloxane)s comprise bisphenol A carbonate units and siloxane units, for example blocks containing 5 to 200 dimethylsiloxane units, such as those commercially available under the trade name EXL from the Innovative Plastics division of SABIC. Examples of poly(ester-carbonate)s includes poly(ester-carbonate)s comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units. Other poly(ester-carbonates include containing bisphenol A carbonate units and isophthalate/terephthalate esters of resorcinol, such as those available under the trade name SLX the Innovative Plastics division of SABIC is a poly(ester-carbonate-siloxane) comprising bisphenol A carbonate units, isophthalate-terephthalate-bisphenol A ester units, and siloxane units, for example blocks containing 5 to 200 dimethylsiloxane units, such as those commercially available under the trade name FST from the Innovative Plastics division of SABIC, Poly(aliphatic ester-carbonate)s can be used, such as those comprising bisphenol A carbonate units and sebacic acid-bisphenol A ester units, for example those commercially available under the trade name LEXAN HFD from the Innovative Plastics division of SABIC.

As described above, a first polymer composition A/second polymer composition B can be a polycarbonate/polyester, or a polycarbonate/polycarbonate and polyester combination, or a polyester/polycarbonate and polyester combination. Specific examples of first polymer composition A/second polymer composition B include polyamide/polyamide and poly(phenylene ether), polypropylene/polypropylene and poly(phenylene ether), polycarbonate/polyetherimide, polyetherimide/poly(etherimide-siloxane) copolymer, polyetherimide/polyimide, polycarbonate/acrylonitrile-butadiene-styrene copolymer, polycarbonate/acrylonitrile-styrene-acrylate polymer, polycarbonate/poly(butylene terephthalate), polycarbonate/polycarbonate and poly(butylene terephthalate), polybutylene terephthalate/polycarbonate and poly(butylene terephthalate), polycarbonate/poly(ethylene terephthalate), polycarbonate/polycarbonate and poly(ethylene terephthalate), poly(ethylene terephthalate)/polycarbonate and poly(ethylene terephthalate), polycarbonate/poly(1,4-cyclohexanedimethyl-1,4-cyclohexanedicarboxylate), polycarbonate/polycarbonate and poly(1,4-cyclohexanedimethyl-1,4-cyclohexanedicarboxylate), poly(1,4-cyclohexanedimethyl-1,4-cyclohexanedicarboxylate)/polycarbonate and poly(1,4-cyclohexanedimethyl-1,4-cyclohexanedicarboxylate), polystyrene/poly(phenylene ether), polystyrene/polystyrene-poly(phenylene ether) combination, poly(methyl methacrylate)/styrene-acrylonitrile, poly(methyl methacrylate)/poly(ethylene oxide), poly(methyl methacrylate)/epichlorohydrin polymer, poly(methyl methacrylate)/polycarbonate, acrylonitrile styrene acrylate polymer/acrylonitrile butadiene styrene polymer, or polycarbonate/styrene-acrylonitrile.

The polymer composition can include various additives ordinarily incorporated into polymer compositions of this type, with the proviso that any additives are selected so as to not significantly adversely affect the desired properties of the composition, in particular the melt flow index. Such additives can be mixed at a suitable time during the mixing of the components for forming the composition. Additives include nucleating agents, fillers, reinforcing agents, antioxidants, heat stabilizers, light stabilizers, ultraviolet (UV) light stabilizers, plasticizers, lubricants, mold release agents, surfactants, antistatic agents, colorants such as titanium dioxide, carbon black, and organic dyes, surface effect additives, radiation stabilizers, flame retardants, and anti-drip agents. A combination of additives can be used, for example a combination of a heat stabilizer and ultraviolet light stabilizer. In general, the additives are used in the amounts generally known to be effective. For example, the total amount of the additives (other than any impact modifier, filler, or reinforcing agents) can be 0.01 to 20 wt. %, based on the total weight of the polymer composition.

In other embodiments, an exterior shell (or other component) can be formed from polymer compositions and then used as a substrate for the additive manufacturing process. In other embodiments, a shell can be partially or completely filled by forming a core at least in part by additive manufacturing as described herein. The core accordingly includes at least two adjacent layers comprising different polymer compositions. It is also contemplated that the core of an article can be formed first by additive manufacturing as described herein, and an exterior shell (or other component) can then be formed or attached. The exterior shell or other component can also be formed by additive manufacturing, for example using material extrusion methods.

Once formed, in some embodiments a surface of the article can be shaped, smoothed, or otherwise manipulated using a heated tool such as a knife, paddle, or molding tool. The surface can be an intermediate layer or a final layer. In other embodiments, a surface of the article can be smoothed or manipulated by applying a solvent for the layer or a varnish. Application of the solvent or the varnish can occur by dipping, spraying, brushing, or other appropriate method. Varnish, as used herein, describes a polymer precursor or combination of polymer precursors that can be applied, and then polymerized.

Forming of articles with at least two layers comprising different polymer compositions can allow the different layers to have different properties, for example different stiffnesses, different wear, different impact, colors, and the like, based on a desired application.

In some embodiments the printed object produced by the method of the disclosure has improved mechanical characteristics when compared with objects made by a method in which all layers comprise the same polymer composition. Improved characteristics can include tensile modulus, tensile strength, elongation at break, flexural modulus, and flexural strength.

The present claims are further illustrated by the following Embodiments.

Embodiment 1. A method of making an article, the method comprising: melt extruding a plurality of layers comprising one or more polymers in a preset pattern, wherein the extruded layers comprise one or more first layers comprising a first polymer composition A, and one or more second layers comprising a second polymer composition B different from polymer composition A, and fusing the plurality of layers to provide the article.

Embodiment 2. The method of claim 1, further comprising melt extruding 1+n additional layers comprising different polymer compositions C(1+n), wherein n is zero, 1, or greater than 1; and each of the polymer compositions C(1+n) is different from polymer compositions A, B, and each other.

Embodiment 3. The method of claim 1, comprising melt extruding the plurality of layers in an alternating regular polymer composition sequence (AₚB_{q})ₓ wherein p is the number of adjacent layers comprising polymer composition A and is 1 to 30, preferably 1 to 20, more preferably 1 to 10, even more preferably 1 to 5, and q is the number of adjacent layers comprising polymer composition B, and is 1 to 30, preferably 1 to 20, more preferably 1 to 10, even more preferably 1 to 5; and x is the number of times the sequence is repeated and is at least 1, preferably wherein (p+q)*x is at least 1%, at least 10%, at least 25%, at least 50%, at least 80%, or at least 90% of the total number of layers in the article.

Embodiment 4. The method of claim 3, wherein p and q are each 1.

Embodiment 5. The method of claim 3, wherein p and q are not the same.

Embodiment 6. The method of claim 3, wherein in the polymer composition sequence (AₚB_{q})ₓ, x is greater than 1, and the value of p varies, or the value of q varies, or both the value of p and the value of q vary.

Embodiment 7. The method of any one of claims 1 to 6, comprising melt extruding the plurality of layers wherein at least one layer is extruded comprising a third polymer composition C(1), wherein polymer composition C(1) is different from polymer compositions A and B.

Embodiment 8. The method of claim 7, comprising melt extruding the plurality of layers in a polymer composition sequence (AₚB_{q}C(1)ᵣ)_{y}, wherein p is the number of adjacent layers extruded comprising polymer composition A and is 1 to 30, preferably 1 to 20, more preferably 1 to 10, even more preferably 1 to 5, q is the number of adjacent layers extruded comprising polymer composition B, and is 1 to 30, preferably 1 to 20, more preferably 1 to 10, even more preferably 1 to 5, r is the number of adjacent layers extruded comprising polymer composition C(1), and is 1 to 30, preferably 1 to 20, more preferably 1 to 10, even more preferably 1 to 5, and y is number of times the sequence is repeated, preferably wherein (p+q+r)*y is at least 1%, at least 10%, at least 25%, at least 50%, at least 80%, or at least 90% of the total number of layers in the article.

Embodiment 9. The method of any one or more of claims 1 to 8, comprising melt extruding a plurality of four or more different layers, wherein each different layer comprises a polymer composition different from the polymer compositions of the other layers.

Embodiment 10. The method of any one or more of claims 1 to 9, comprising extruding each of the layers comprising the same polymer composition through the same nozzle and each of the layers comprising a different polymer composition through a different nozzle.

Embodiment 11. The method of any of claims 1 to 10, wherein each different polymer composition comprises the same polymer.

Embodiment 12. The method of any of claims 1 to 10, wherein each different polymer composition comprises a different polymers.

Embodiment 13. The method of claim 11, wherein the different polymer compositions are compatible with each other at an interface between them.

Embodiment 14. The method of any of claims 12 to 13, wherein the different polymer compositions are compatible in bulk.

Embodiment 15. The method of any one or more of claims 1 to 12, wherein the polymer composition comprises a polyacetal, polyacrylate, polyacrylic, polyamide, polyamideimide, polyanhydride, polyarylate, polyarylene ether, polyarylene sulfide, polybenzoxazole, polycarbonate, polyester, polyetheretherketone, polyetherimide, polyetherketoneketone, polyetherketone, polyethersulfone, polyimide, polymethacrylate, polyolefin, polyphthalide, polysilazane, polysiloxane, polystyrene, polysulfide, polysulfonamide, polysulfonate, polythioester, polytriazine, polyurea, polyurethane, polyvinyl alcohol, polyvinyl ester, polyvinyl ether, polyvinyl halide, polyvinyl ketone, polyvinylidene fluoride polyvinyl aromatic, polysulfone, polyarylenesulfone, polyaryl ether ketone, polylactic acid, polyglycolic acid, poly-3-hydroxybutyrate, polyhydroxyalkanoate, starch, cellulose ester, or a combination comprising at least one of the foregoing polymers; or the polymer composition comprises a polystyrene, poly(phenylene ether), poly(methyl methacrylate), styrene-acrylonitrile, poly(ethylene oxide), epichlorohydrin polymer, polycarbonate homopolymer, copolycarbonate, poly(ester-carbonate), poly(ester-siloxane-carbonate), poly(carbonate-siloxane), acrylonitrile-butadiene-styrene, or a combination comprising at least one of the foregoing polymers.

Embodiment 16. The method of any one or more of claims 1 to 9 or 11 to 15, wherein the first polymer composition A/second polymer composition B combination is polyamide/polyamide and poly(phenylene ether), polypropylene/polypropylene and poly(phenylene ether), polycarbonate/polyetherimide, polyetherimide/poly(etherimide-siloxane) copolymer, polyetherimide/polyimide, polycarbonate/acrylonitrile-butadiene-styrene copolymer, polycarbonate/acrylonitrile-styrene-acrylate polymer, polycarbonate/poly(butylene terephthalate), polycarbonate/polycarbonate and poly(butylene terephthalate), polybutylene terephthalate/polycarbonate and poly(butylene terephthalate), polycarbonate/poly(ethylene terephthalate), polycarbonate/polycarbonate and poly(ethylene terephthalate), poly(ethylene terephthalate)/polycarbonate and poly(ethylene terephthalate), polycarbonate/poly(1,4-cyclohexanedimethyl-1,4-cyclohexanedicarboxylate), polycarbonate/polycarbonate and poly(1,4-cyclohexanedimethyl-1,4-cyclohexanedicarboxylate), poly(1,4-cyclohexanedimethyl-1,4-cyclohexanedicarboxylate)/polycarbonate and poly(1,4-cyclohexanedimethyl-1,4-cyclohexanedicarboxylate), polystyrene/poly(phenylene ether), polystyrene/polystyrene-poly(phenylene ether) combination, poly(methyl methacrylate)/styrene-acrylonitrile, poly(methyl methacrylate)/poly(ethylene oxide), poly(methyl methacrylate)/epichlorohydrin polymer, poly(methyl methacrylate)/polycarbonate, acrylonitrile styrene acrylate polymer/acrylonitrile butadiene styrene polymer, or polycarbonate/styrene-acrylonitrile.

Embodiment 17. The method of any of claims 1 to 16, wherein the melt extruding of a plurality of layers comprises melt extruding a plurality of layers comprising a build material and melt extruding a plurality of layers comprising a support material.

Embodiment 18. An article made by any of the method of any one or more of claims 1 to 17.

Embodiment 19. An article comprising: a plurality of layers, each layer comprising a polymer composition, wherein one or more first layers comprise a first polymer composition A, and one or more second layers comprise a second polymer composition B different from the first polymer composition A.

Embodiment 20. The method of claim 19, further comprising melt extruding at least one layer comprising a third polymer composition C(1) different from the first polymer composition A and the second polymer composition B.

Embodiment 21. The method of any of claims 1 to 17, wherein the method is a fused filament fabrication additive manufacturing process or a large format additive manufacturing process and the each polymer composition is in the form of filaments or pellets before the melt extruding step.

Embodiment 22. The method of claim 19 or 20, wherein the first and second polymer compositions are compatible with each other at an interface between them.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function and/or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. Reference throughout the specification to “an embodiment”, “another embodiment”, “some embodiments”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein.

Accordingly, various modifications, adaptations, and alternatives can occur to one skilled in the art without departing from the spirit and scope herein.

1. A method of making an article, the method comprising:
melt extruding a plurality of layers comprising one or more polymers in a preset pattern, wherein the extruded layers comprise
one or more first layers comprising a first polymer composition A, and
one or more second layers comprising a second polymer composition B different from polymer composition A,
and
fusing the plurality of layers to provide the article.

2. The method of claim 1, further comprising melt extruding 1+n additional layers comprising different polymer compositions C(1+n), wherein n is zero, 1, or greater than 1; and each of the polymer compositions C(1+n) is different from polymer compositions A, B, and each other.

3. The method of claim 1, comprising melt extruding the plurality of layers in an alternating regular polymer composition sequence (AₚB_{q})ₓ wherein
p is the number of adjacent layers comprising polymer composition A and is 1 to 30, and
q is the number of adjacent layers comprising polymer composition B, and is 1 to 30; and
x is the number of times the sequence is repeated and is at least 1.

4. The method of claim 3, wherein p and q are each 1.

5. The method of claim 3, wherein p and q are not the same.

6. The method of claim 3, wherein in the polymer composition sequence (AₚB_{q})ₓ, x is greater than 1, and the value of p varies, or the value of q varies, or both the value of p and the value of q vary.

7. The method of claim 1, comprising melt extruding the plurality of layers wherein at least one layer is extruded comprising a third polymer composition C(1), wherein polymer composition C(1) is different from polymer compositions A and B.

8. The method of claim 7, comprising melt extruding the plurality of layers in a polymer composition sequence (AₚB_{q}C(1)ᵣ)_{y}, wherein
p is the number of adjacent layers extruded comprising polymer composition A and is 1 to 30,
q is the number of adjacent layers extruded comprising polymer composition B, and is 1 to 30,
r is the number of adjacent layers extruded comprising polymer composition C(1), and is 1 to 30, and
y is number of times the sequence is repeated.

9. The method of claim 1, comprising melt extruding a plurality of four or more different layers, wherein each different layer comprises a polymer composition different from the polymer compositions of the other layers.

10. The method of claim 1, comprising extruding each of the layers comprising the same polymer composition through the same nozzle and each of the layers comprising a different polymer composition through a different nozzle.

11. The method of claim 1, wherein each different polymer composition comprises the same polymer.

12. The method of claim 1, wherein each different polymer composition comprises a different polymers.

13. The method of claim 11, wherein the different polymer compositions are compatible with each other at an interface between them.

14. The method of claim 12, wherein the different polymer compositions are compatible in bulk.

15. The method of claim 1, wherein the polymer composition comprises a polyacetal, polyacrylate, polyacrylic, polyamide, polyamideimide, polyanhydride, polyarylate, polyarylene ether, polyarylene sulfide, polybenzoxazole, polycarbonate, polyester, polyetheretherketone, polyetherimide, polyetherketoneketone, polyetherketone, polyethersulfone, polyimide, polymethacrylate, polyolefin, polyphthalide, polysilazane, polysiloxane, polystyrene, polysulfide, polysulfonamide, polysulfonate, polythioester, polytriazine, polyurea, polyurethane, polyvinyl alcohol, polyvinyl ester, polyvinyl ether, polyvinyl halide, polyvinyl ketone, polyvinylidene fluoride polyvinyl aromatic, polysulfone, polyarylenesulfone, polyaryl ether ketone, polylactic acid, polyglycolic acid, poly-3-hydroxybutyrate, polyhydroxyalkanoate, starch, cellulose ester, or a combination comprising at least one of the foregoing polymers; or
the polymer composition comprises a polystyrene, poly(phenylene ether), poly(methyl methacrylate), styrene-acrylonitrile, poly(ethylene oxide), epichlorohydrin polymer, polycarbonate homopolymer, copolycarbonate, poly(ester-carbonate), poly(ester-siloxane-carbonate), poly(carbonate-siloxane), acrylonitrile-butadiene-styrene, or a combination comprising at least one of the foregoing polymers.

16. The method of claim 1, wherein the first polymer composition A/second polymer composition B combination is polyamide/polyamide and poly(phenylene ether), polypropylene/polypropylene and poly(phenylene ether), polycarbonate/polyetherimide, polyetherimide/poly(etherimide-siloxane) copolymer, polyetherimide/polyimide, polycarbonate/acrylonitrile-butadiene-styrene copolymer, polycarbonate/acrylonitrile-styrene-acrylate polymer, polycarbonate/poly(butylene terephthalate), polycarbonate/polycarbonate and poly(butylene terephthalate), polybutylene terephthalate/polycarbonate and poly(butylene terephthalate), polycarbonate/poly(ethylene terephthalate), polycarbonate/polycarbonate and poly(ethylene terephthalate), poly(ethylene terephthalate)/polycarbonate and poly(ethylene terephthalate), polycarbonate/poly(1,4-cyclohexanedimethyl-1,4-cyclohexanedicarboxylate), polycarbonate/polycarbonate and poly(1,4-cyclohexanedimethyl-1,4-cyclohexanedicarboxylate), poly(1,4-cyclohexanedimethyl-1,4-cyclohexanedicarboxylate)/polycarbonate and poly(1,4-cyclohexanedimethyl-1,4-cyclohexanedicarboxylate), polystyrene/poly(phenylene ether), polystyrene/polystyrene-poly(phenylene ether) combination, poly(methyl methacrylate)/styrene-acrylonitrile, poly(methyl methacrylate)/poly(ethylene oxide), poly(methyl methacrylate)/epichlorohydrin polymer, poly(methyl methacrylate)/polycarbonate, acrylonitrile styrene acrylate polymer/acrylonitrile butadiene styrene polymer, or polycarbonate/styrene-acrylonitrile.

17. The method of claim 1, wherein the melt extruding of a plurality of layers comprises melt extruding a plurality of layers comprising a build material and melt extruding a plurality of layers comprising a support material.

18. An article made by any of the method of claim 1.

19. An article comprising
a plurality of layers, each layer comprising a polymer composition, wherein
one or more first layers comprise a first polymer composition A, and
one or more second layers comprise a second polymer composition B different from the first polymer composition A.

20. The article of claim 19, further comprising at least one layer comprising a third polymer composition C(1) different from the first polymer composition A and the second polymer composition B.

21. The method of claim 1, wherein the method is a fused filament fabrication additive manufacturing process or a large format additive manufacturing process and the each polymer composition is in the form of filaments or pellets before the melt extruding step.
